(19) United States
(12) Patent Application Publication
(10) Pub. No.: US 2011/0066724 A1
(43) Pub. Date: Mar. 17, 2011

(54) SYSTEMS AND METHODS FOR DIRECTION OF COMMUNICATION TRAFFIC

(76) Inventors: Alan SULLIVAN, Leesburg, VA (US); Mark Lewyn, Washington, DC (US); Sezen Uysal, Vienna, VA (US)

(21) Appl. No.: 12/947,400

(22) Filed: Nov. 16, 2010

Related U.S. Application Data
(63) Continuation of application No. 11/556,235, filed on Nov. 3, 2006, now abandoned.
Application No. 11/556,235 is a continuation of application No. 11/019,369, filed on Dec. 23, 2004, now abandoned.
Application No. 11/019,369 is a continuation-in-part of application No. 10/837,614, filed on May 4, 2004.
Application No. 10/837,614 is a continuation-in-part of application No. 10/065,529, filed on Oct. 27, 2002, now Pat. No. 7,310,686.
(60) Provisional application No. 60/467,246, filed on May 5, 2003.

(51) Int. Cl. G06F 15/173

(52) U.S. Cl. 709/224

(57) ABSTRACT

An internet traffic redirection architecture is disclosed that allows for directing of various traffic to specified sites. The system and method allow a controller, such as an ISP, to benefit from unresolved IP Address requests and keyword and hotword queries by capturing this traffic and directing it to participating partners who provide content relevant and/or geographically relevant results. The system and method can decrease lost traffic, irrelevant keyword and hotword search results, and irrelevant redirection by web browsers resident on user's personal computers.

### CROSS-REFERENCE TO RELATED APPLICATIONS

This application is a Continuation application of U.S. patent application Ser. No. 11/019,369, filed 23 Dec. 2004, which is a Continuation-In-Part application of U.S. patent application Ser. No. 10/837,614, filed 4 May 2004, which relies on and claims the benefit of the filing date of U.S. Provisional patent application No. 60/467,246, filed 5 May 2003, and a Continuation-In-Part of U.S. patent application Ser. No. 10/065,529, filed 27 Oct. 2002. The application claims the benefit of the filing date of all of these applications, and the entire disclosures of all of these are incorporated by reference herein in their entireties.

### BACKGROUND OF THE INVENTION

1. Field of the Invention

The present invention relates generally to traffic direction within a communications network. More specifically, the present invention relates to systems and methods for directing communication traffic to a specified location in response to a query, directing communication traffic to a specified location when an original location is not reachable, and providing one or more suitable locations in response to a general query for a location or service.

2. Background of the Invention

The internet is a global network of individual computers linked to each other by domain name servers (DNS). In this global network, each individual computer is assigned a unique identifying number called an internet Protocol Address or IP Address. The IP Address of each computer in the network is stored in one or more DNS. The IP Address is provided by the DNS to other computers in response to queries searching for the IP Address. Providing the IP Address of the target computer to the requesting computer permits the requesting computer to make contact with the target computer.

Typically, computer users do not know the actual IP Address of the computer they wish to contact. Rather, they know the name, in a human language, of the web page or e-mail address they wish to contact. Therefore, they cannot connect directly to the computer of interest, but must rely on the internet infrastructure to provide them the correct IP Address and make a connection to the target computer. In a common scenario, the user types into the internet browser resident on his personal computer a particular web site of interest in the form of a Uniform Resource Locator (URL; e.g., http colon double slash www dot paxfire dot com). The browser on the user's computer sends a request to a DNS (typically a DNS owned and/or operated by his internet Service Provider (ISP)) to convert the URL to an IP Address, and find the IP Address for it. The DNS then converts the URL request to an IP Address request, and determines if it knows where the IP Address is located on the internet. If it knows this information, it supplies it to the user's browser, and a connection between the two computers is made. If it does not know this information, it makes a request to a Root DNS to provide information on the requested IP Address. If the Root DNS knows the requested IP Address, it provides the DNS with the Address, and the DNS supplies it to the requester so that a connection can be made. If the Root DNS does not know the requested IP Address, the Root DNS provides the DNS with the addresses of DNS servers that maintain lists of all IP Addresses associated with the requested IP Address (e.g., all addresses that include.com, .gov, .biz, .net, etc.). These DNS are referred to as registry (or top-level or first-level) DNS. The DNS then contacts one or more registry DNS to request the IP Address, and, if the requested IP Address exists, a registry DNS returns the IP Address of a DNS that knows the requested IP Address. If the requested IP Address does not exist, the registry DNS informs the DNS that the request was unresolved, and the DNS passes this information back to the user's browser. If the requested IP Address exists, the DNS then contacts the DNS that knows the requested IP Address, and asks for the IP Address. The second DNS forwards the IP Address to the first DNS, and it passes the IP Address down to the user's browser, and a connection is made between the two computers.

In the event that the requested IP Address is unresolved, the user's browser typically displays some sort of error message informing the user of the problem. Often, the browser also automatically directs the user to a web page that is unrelated to the desired web page, or to a web page that contains various advertisements, which might or might not be relevant to the subject of the original search by the user.

While the particular details of telephony, Instant Messaging (IM), Voice Over IP (VoIP), and other technologies that rely on the internet to traffic information might differ in certain aspects, the same general “up-and-down” communication among servers within the internet infrastructure is used to identify telephone numbers, usernames, addresses, etc. and to make connections between a requestor and a target or to deliver error messages when a failed look-up occurs.

Often, internet users, telephone callers, IM customers, etc. do not know the precise web page, telephone number, etc. they are looking for. Rather, they simply know the general subject matter or field in which their query is relevant. In the case of an internet search, users typically go to the site of an internet search engine, such as Google®, Yahoo®, and Jeeves® (or use a search bar that has been downloaded from a search engine onto their web browser), and type in a hotword, keyword, or string of hotwords or keywords that are relevant to their query. In response to the hotword search, the search engine consults its cache of web pages and metatags associated with each, and typically returns one or more URL, from which the requestor can select the most appropriate web page for his purposes. In response to the keyword search, the search engine consults its list of metatags, and returns a single web page. When the hotword or keyword does not match any stored metatag, the search engine will return some sort of error message or message indicating that no web sites contain the information recited in the request.

As used herein, a hotword is a word that is a subject of the query, and which results in a search that returns one or more URL that are relevant to the query. For example, a hotword might be “car” and the result of the search would be a list of web sites of car manufacturers, car dealerships, car repair shops, car enthusiast clubs, and the like. Hotword searches are typical in the internet trafficking field, and can be generally thought of as the typical query submitted by a user when searching the internet for information on a topic of interest, usually using a search engine. Internet searches contain one or more hotwords. In contrast, as used herein, a keyword is a word or phrase that is a subject of a query, and for which a specific web page (rather than a series of links to potentially relevant web pages, as in a hotword search) is returned. Thus, a keyword search results in mapping of the word to a domain name, and IP Address or alias domain name. For example, a hotword might be “car” and the result would be connection of the requestor's computer to the Ford Motor Company web site.

Directing search traffic on the web is a common and often lucrative process. For example, popular web browsers, such as Microsoft internet Explorer®, typically redirect misspelled and mistyped web page queries, and other queries that are unresolved for other reasons, to a website or search page, such as MSN® Search, selected and dictated by the web browser and thus the web browser manufacturer. Such search pages typically provide the user with possible correct search queries, various search options, and advertising. Mistyped e-mail addresses are typically not redirected, but simply returned as “undeliverable”. The essence of the concept of redirection currently used in the art is that it captures the mistyped or misspelled traffic at either the browser level (for URL requests), on the computer of the individual submitting the query. These methods lack the capability to function at the domain name server/service (DNS) level, thus limiting their overall functionality and ability to be able to provide business services. As they are resident on each user's computer, they suffer from all of the well-known problems associated with plug-ins and cookies.

Various methods of routing or redirecting traffic are known in the art. For example, methods of routing traffic are taught in U.S. Pat. No. 6,631,402. Methods of redirecting or routing of data traffic are taught in U.S. Pat. No. 6,608,893, U.S. Pat. No. 5,933,490, U.S. Pat. No. 6,205,477, and U.S. published patent application number 2004/0042447 A1. Methods of routing error corrections are taught, for example, in U.S. Pat. No. 6,601,208. Routing methods for load balancing are taught, for example, in U.S. Pat. No. 6,182,139 and U.S. Pat. No. 5,774,660. Internet traffic routing is taught in U.S. Pat. No. 5,987,611, for example. Methods for dealing with invalid requests are taught in U.S. published patent application number 2004/0030780 A1, for example.

Likewise, methods of marketing and communication traffic selling are known. For example, such methods are taught in U.S. published patent application number 2004/0044566 A1. URL (uniform resource locator) redirect methods are taught in U.S. published patent application number 2004/004622 A1, for example. DNS resource lookup methods are taught in U.S. published patent application number 2004/0044791 A1, for example. Methods of implementing a web-based proxy are taught in U.S. Pat. No. 6,631,402, for example.

Although there are numerous drawbacks to the systems and methods currently available, one key drawback of current redirect methods is that they lack the ability to perform service task at the DNS level of operation, thus limiting the functionality and capability of such systems and methods. Furthermore currently available redirect methods are diminished in capacity due to the level at which these elements operate within the internet infrastructure or internet architecture, thus limiting the ability of current redirect methods in conducting reliable business services, such as payment processing, e-commerce, ENUM, IP telephony, VoIP, filtering, security, URL forwarding, and associated tracking methods, such as market channel tracking, webpage usages, DNS statistics, traffic redirection, and information storage or backup.

Thus there is a need in the art for systems and methods of traffic direction or redirection that are not limited in the layer (or level) at which they are able to function and that allow for conducting reliable business services and associated tracking methods. In particular, there is a need for methods and systems for direction of communication traffic, whether it be telephony or internet or some other communication traffic, that permits redirection of invalid queries or general queries that are not specific to a particular destination, to be directed to a site or page where relevant information can be provided to the individual submitting the query, and where the methods and systems do not reside on the individual's personal computer or require system resources of the individual's personal computer to implement and maintain.

### SUMMARY OF THE INVENTION

The present invention provides systems and methods that provide content-relevant subject matter to a requestor in response to an unresolved query (including hotword and keyword searches, as discussed below). An integrated systems implementing the methods of the invention are referred to herein at points as an internet appliance, and such a term should be interpreted as referring to the systems, methods, or both, of the invention. In one aspect, the invention provides an internet appliance for redirection of improper or incorrect requests (i.e., unresolved queries). The present invention also provides an internet appliance for identifying the geographic location of the requestor and providing geographically relevant content in return to a query, whether the query be an invalid query, a valid query for a specific website, or a valid query for general information on a subject (e.g., a keyword or hotword search query, as would be typed in any of the numerous search engines available on the internet). The present invention further provides an internet appliance that provides content-relevant information to be supplied to a requestor based on the time that a query is submitted. Relevant content can be based on search terms used, and can include web pages provided by paid advertisers, web pages identified based on metatags, or both.

When the request is unresolved, when it relates to subject matter that is of interest to a participating partner (discussed in detail below), or both, the internet appliance of the invention can redirect the request to a proxy host (referred to herein as a “PSP”), which analyzes the request and provides a context-relevant search result rather than an error message, which would otherwise be sent to the requestor from the DNS. In preferred embodiments, the internet appliance resides at the service provider level (i.e., at the ISP or Session Initiation Protocol (SIP) level), rather than the user level, and thus does not take up resources on the user's personal computer. In addition, by providing the internet appliance at the ISP level, the problems associated with cookies and plug-ins are avoided. Furthermore, because the internet appliance of preferred embodiments operates at the ISP level rather than the browser level, no personal information about the user/requestor is placed on the public network of the internet. The internet appliance of preferred embodiments also provides dynamic, real-time updated information without reading or writing any information from or to the user's personal computer.

The present invention accordingly provides systems and methods for conducting business using computers. The systems and methods include identifying queries containing unresolvable or unresolved information, and redirecting these queries to web pages that contain relevant information, which can be provided by advertisers who pay an ISP DNS, enterprise DNS, or the like, operator for inclusion of their content on the redirect web page. The systems and methods thus include identifying general queries (i.e., keyword or hotword searches) and redirecting these general queries to web pages that contain relevant information, which can be provided by advertisers who pay the ISP DNS, enterprise DNS, etc. operator for inclusion of their content on the redirect web page.

### BRIEF DESCRIPTION OF THE DRAWINGS

FIG. 1 shows a request and response generated in accordance with an exemplary embodiment of the invention with no traffic direction initiated.

FIG. 2 shows an exemplary implementation of the direction method of the invention when a malformed request is initiated.

FIG. 3 shows an exemplary implementation of the direction method of the invention wherein redirection of a request is initiated.

FIG. 4 shows an exemplary embodiment of the present invention wherein a local plug-in is used.

FIG. 5A depicts internet-based PLP (PLE) control by an ISP.

FIG. 5B depicts local-based PLP (PLE) control by an ISP.

FIG. 6 shows an implementation of the direction method in accordance with an exemplary embodiment of the present invention wherein two components of the invention, the Lookup Proxy (PLP) and the Search Profiler or Proxy Host (PSP), exchange information and control data.

FIG. 7 shows an implementation of the overall architecture used to implement the direction system and method in accordance with an exemplary embodiment of the present invention.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description describes certain embodiments of the invention, and should not be considered as limiting the invention to those embodiments.

The internet provides a user a quick and efficient direction to a particular web site or web page if the user knows the exact web site or web page address, either through its IP Address or through its URL. The majority of internet users properly type in the exact address of the web site or web page that they are seeking and thus are directed to such sites or pages. However, a user will quite often type in an address that is not recognized, thereby leading the user to an error page or a specific search engine page. As used herein and in the art, such an invalid, erroneous, or unresolvable query is considered as unwanted, unused, or unresolved traffic from the standpoint of internet infrastructure providers. From the perspective of the user (i.e., the person submitting the query) and as used herein and in the art, receiving an error message or being directed to an error page containing a simple error message or content that is not relevant to the original query or intended query is an undesirable or unwanted result. Another popular name for URL addresses that lead to no proper destination, and result in error messages or direction to error pages is “trash traffic”. By “unresolved”, it is meant any query that is not in a proper form for a DNS to supply a single IP Address that corresponds to the web site, web page, e-mail address, etc. that the requestor intended to reach. Thus, according to the invention, exemplary unresolved queries include mis-typed URLs, mistyped e-mail addresses, mis-typed IM screen names, expired or unused URLs or e-mail addresses, hotwords, keywords, and unassigned telephone numbers, to name but a few. Unresolved queries also include IP Addresses for redirect web pages generated by a DNS or by a browser or application resident on a user's computer.

Search engines available on the internet provide a user a quick and efficient means for identifying a particular web site based on keywords or hotwords submitted in a query by the user. They also provide content-relevant advertising based on the keyword or hotword submitted by the user. Unfortunately, the web sites and advertising provided by the search engines in response to the query do not take into account the geographic location of the particular user submitting the query, unless the user specifically provides information on his location, either by manually entering the information in response to a request from the web site, or by transmission from a cookie. Thus, for example, in response to a query about art shows, a user in the Washington, D.C. metropolitan area might be directed to web site dedicated to art shows in Tennessee, Mexico, Japan, India, or anywhere else in the world. Likewise, in response to a query about the availability a certain model automobile for purchase, the search engine might provide results that list the major car manufacturers and car clubs, neither of which would contain the desired results (i.e., a car dealership in the requestor's immediate geographical area that sells the car of interest). Furthermore, the search engines do not take into account the time that the query was made, and thus cannot intentionally provide time-relevant results. Because results from search engines typically are ranked based, at least in part, on number of visits to various web sites, sites of large or popular corporations or organizations generally are displayed as the highest ranking results, and more relevant results may be buried well below these results.

Users generally either initially or ultimately type the correct URL into their browser search bar or are directed to the correct URL by a search engine or redirect web page. Because of the volume of traffic at certain commercial web sites, such as those run by major international companies or high-volume retailers, the commercial web site hosts often maintain numerous servers throughout the country and world, each server providing the web site for the company. To provide the fastest connection, users are optimally connected to the geographically closest server to them or the server requiring the fewest connections between DNS servers (i.e., the fewest “hops”) to be made, if such a server is available. However, typing in the URL in the search bar, even if correct, and clicking on the URL provided by a search engine, does not necessarily mean a user will be connected to the geographically closest server containing the desired web page or the server that requires the fewest hops to reach. Thus, even where a user successfully connects to a web page of interest, the connection is not necessarily the fastest.

The present invention offers a solution to problems associated with these types of information trafficking by analyzing internet requests submitted by users, resolving various information, including but not limited to, the validity, time, content, and/or geographical location of origin of the request, and directing the request to the desired web page, at the closest (based on geography or number of hops required) available server to the requestor, a content-relevant web page, or a page providing one or more content-relevant URLs from which the user may select the most appropriate. The web page to which the user is directed may be any web page, including, but not limited to a search engine, an advertising page, or some combination of both. It also may be another page that allows a “controller” to benefit from the redirection of the user traffic. Such a controller may be, for example, an ISP. Limitations and difficulties in the current state of the art in the area of redirecting network traffic are addressed by the present invention, which reside in the systems and methods for the direction of communication traffic and the resulting production of capital for various applications.

The systems and methods according to the present invention are suitable for use in any computer-driven communications system, such as internet systems and telephony. As such, the present internet appliance can be implemented at the registry, ISP, or other level of the internet architecture. This is a significant departure from currently used technologies, which are limited to the browser or application level. For example, implementation of the internet appliance of the invention at the ISP level permits geographically-relevant and time-relevant content to be provided to the requestor (a facet of the invention that cannot be provided when sitting at the registry level of communication traffic direction) and avoids use and burdening of individual personal computers to store information relevant to the numerous different types of searches possibly enacted by each user. In embodiments, it also protects the requestor's IP Address from being transmitted over the public network of the internet, providing security not provided by other redirect systems known in the art. Furthermore, in embodiments, the internet appliance of the invention can provide very high security to the user by monitoring and blocking access to open ports on a computer taking part in internet traffic.

The internet appliance according to the present invention provides a more robust experience for the internet user while allowing the local computer to conduct other tasks. Regardless of whether the systems and methods are implemented at the registry level or ISP level, resources of users' personal computers are freed (as compared to systems and methods relying on browser or application level implementation of other systems) and not required to participate in direction of the browser to a landing page. Although it is possible to implement the systems and methods of the invention at the registry level, there are advantages to implementing the systems and methods at the ISP level. One exemplary advantage is to be able to geo-locate a requestor based on his IP Address, which is not transmitted from the ISP level to the registry level, and thus not available to the internet appliance if implemented at that level. Another exemplary advantage relates to the ability to have final control over information presented to the user. More specifically, if a registry DNS incorporates a redirection system other than the present system, it will return a particular redirect IP Address as a redirect landing page when it determines that an unresolvable query has been sent by a user. However, if the present internet appliance is implemented at the ISP level, it can intercept the redirect IP Address sent by the registry DNS, treat it as an unresolved query, and provide a redirect landing page in place of the redirect landing page supplied by the registry level system. Furthermore, because in preferred embodiments the present systems and methods would reside, at least partially, on the user side of the ISP (or at least partially within the ISP DNS), information about the user's location will be available to the internet appliance, and that information can be blended with other information to provide a content-relevant redirect landing page in response to the unresolved query.

The invention as described herein provides a way to eliminate the need to redirect lost queries, trash traffic, or other unresolved queries at the browser or application level by doing so at a higher level, such as at the registry or ISP level. One of the many advantages provided by this shift to the registry or ISP level is to eliminate the ability of individual companies supplying internet browsers to users to filter a single IP address (i.e., route all trash traffic to a single IP Address) because the present systems and methods can return multiple IP Addresses from a pool of IP Addresses maintained on a network of machines. More specifically, in embodiments the present internet appliance provides for multiple redirect landing pages, each with its own IP Address, and the use of a rotating assignment of those IP Addresses in response to detection of each erroneous query. Thus, even if browser manufacturers wished to program into the browser a list of IP Addresses used by the present internet appliance, and instruct the browser to redirect from the IP Addresses supplied by the present systems and methods to a different IP Address, the list of IP Addresses would need to be updated continuously (such as each time the user logged on), and would require each user to download a new file at each logon.

Under the current regime, redirection is dictated by the browser manufacturer, which typically sends unresolved traffic to a site owned by the manufacturer. Content is limited by pre-defined criteria dictated by the browser manufacturer, and is thus limited based on the type of browser installed on a user's personal computer. The present invention frees users from this limitation, and permits content-relevant, geographically-relevant, and/or time-relevant information, and/or geographically proximal connections from and to multiple sources to be provided to the user in response to unresolved traffic or traffic that has a geographically-relevant or time-relevant context.

An issue in internet traffic redirection design is the communications between the customer and ISP. Current systems and methods are relatively inflexible with respect to the manner in which they generate the required code transfers for such rerouting or redirecting of internet traffic at the DNS level of operation. For example with Akamai html content distribution, typically, a user would fetch an html document from a primary server. For example, it will fetch index.html from cnn.com. The URLs for replicated web site content are replaced in the html. For example http colon double slash cnn dot com slash af slash x dot gif is replaced with http colon double slash a73 dot g dot akamaitech dot net slash 7 slash 23 slash cnn dot com slash af slash x slash gif. At this point, the client is forced to resolve a73 dot g dot akamaitech dot net hostname through a DNS. This is a means for replicating content so that content can be pulled from the closest server for optimizing web browser performance. However, this type of methodology is associated with various problems. For example, only static content can be replicated. The modified name contains the original file name, and so the directory structure must be updated when the main web site is updated. A specialized http server must be asked for content where a check of the DNS cache is made to see if the server has been requested. If it has not, it must make multiple calls to the primary server with a very long TTL (time to live) setting for the result. This means that specialized servers must remain fairly static. If the request is made for a name not in the cache, the root server must be contacted, which returns a NS record for akamai.net. The akamai.net name server then returns a NS record for g.akamaitech.net. The name server is chosen to be in a region of the client's name server. G.akamaitech.net nameserver chooses a server in the region. The impact on DNS usage is that DNS is used for server selection more and more. Because of TTL issues, the structure of the DNS servers and HTTP servers need to be fairly static, and it is tough to discern what a reasonable TTL is for this type of use. Internet users will typically want to adapt to load changes, but the current way DNS is used, this is not possible. A superior methodology, which is encompassed by the present invention, uses a dynamically changeable rule set in the PLE to directly redirect DNS requests. Then change could be made in real time to the PLE, therefore off-loading the requests from the DNS system.

Exemplary systems and methods in accordance with the present invention are accomplished by incorporating the use of a unique means of traffic direction or redirection, being used synonymously herein and through this application, wherein the use of registry or ISP level protocols is applied in a manner that creates advantages over currently available redirect systems. Although applicable to registry level implementation, in preferred embodiments, the present invention integrates redirection instruction software, labeled herein as Lookup Proxy (“PLP”) or Lookup Engine (“PLE”), partially or wholly within the ISP server machines, or as a separate proxy server sitting partially or wholly between the ISP and the user, between the ISP server and the registry server, or between the DNS server and the user. Although generally presented herein as a single unit or piece of hardware and software, the present invention can be implemented as functional units, each independently being carried out on the same or a different piece of hardware as any other functional unit. According to the setup of the system of the present invention, lost traffic, other unresolved queries, or general queries for information can not only be resolved to the user's satisfaction, but can also be converted into profit for the ISPs or other entities operating a DNS through direction of traffic to a predetermined web site or web page, or through display of advertising on the search result page provided to the user in response to an unresolved query or a keyword or hotword query. Such profits may be distributed through participating partners and/or stored for later use in an online account when the partner can take action, thus increasing the overall efficiency of the monetary exchange system and adding stability and safety to the partner's funds. Thus, the present systems provide methods of conducting business using a computer, such as over the internet.

The systems and methods of the present invention are implemented by way of computers and computer programs. The systems comprise one or more computers comprising integrated circuits for processing of information. Unlike other redirect systems known in the art, which function at the browser level or at a high level of the internet architecture, such as at Layer 6, the systems of the present invention can work at Layer 2 of the internet architecture (i.e., at the second layer of the OSI model), receiving, processing, and sending information as packets of bits of information. In embodiments where it is implemented at Layer 2, it can provide numerous other functions in addition to redirection of unresolved queries. The present invention contemplates all such functions. Regardless of the layer at which the systems and methods operate, the systems and methods can be, but are not necessarily, implemented without the need to install any new hardware or software into registry or ISP servers, and thus are modular, highly adaptable, and easy and cost-effective to implement and update on one or numerous servers. In embodiments, such as those where the systems and methods function at Layer 2, they are faster than systems currently in use, permit pattern matching without having to go up and down the various layers of the internet architecture, do not block ISP DNS function in the event of a failure (information continues to pass through to and from the ISP DNS, it simply is not processed by the present systems), and are capable of resolving non-ASCII character sets, which is an advantage for queries submitted in languages not encompassed by the ASCII set, such as various Asian languages. In addition, because the internet appliance of the invention can be provided partially or entirely as software, it can be implemented and maintained (e.g., updated) rapidly, easily, and inexpensively. In embodiments, such as those where the systems and methods function at Layer 3 and 4, they can function as a DNS proxy in which users' queries are addresses to the system. The system can process the DNS queries on behalf of the DNS servers. Similarly, the system would communicate with the DNS servers on behalf of the users. All of the services mentioned before (typo, keyword, hotword, and locality based searches) are processed at the DNS application level (Layer 4); therefore, these services can be provided at that layer.

In embodiments, the internet appliance of the invention sits directly in front of the ISP DNS server (i.e., between the ISP DNS server and the individual computer users). In such embodiments, the internet appliance of the invention can, but does not necessarily, perform the following tasks: processing queries from individual users; passing on to the ISP DNS valid queries or other non-relevant requests; intercepting invalid queries before reaching the ISP DNS and redirecting the invalid queries to web pages containing content-relevant information, or providing content-relevant, geographically-relevant, and/or time-relevant information; passing on to the user/requestor valid information supplied by the registry and ISP DNS servers; and providing content-relevant web pages in response to keyword or hotword queries.

As used herein, non-relevant requests are requests that contain information sent by the user that does not relate to functions desired by the entity implementing the systems and methods of the present invention (e.g., an ISP). More specifically, each person, company, etc. that implements the present systems and methods will be interested in analyzing certain information, capturing certain information, and/or redirecting queries relating to certain information to web pages containing various information (e.g., web pages sponsored by participating partners). Those persons, companies, etc. will not be interested in other information, and will want to filter that information such that it is not processed and does not tie up system resources. Non-relevant requests are those requests defined by the entity implementing the systems and methods as containing information that is not of interest to it, and thus should be filtered out. For example, many entities will want to analyze, capture, and/or redirect only web page queries (i.e., HTTP queries), and thus will not want to process e-mail queries (i.e., SMTP queries). The systems and methods of the invention permit such an entity to filter the SMTP queries, allowing them to either pass through unprocessed or be returned to the sender with an error message to the effect that the query was an unresolved request. Of course, a plethora of other parameters may be used by each individual entity to define relevancy.

Electronic components and connections used in the internet appliance of the invention are those typically used in the computer industry, as are all other structural elements of the systems. In preferred embodiments, the internet appliance of the invention is implemented with one or more ISP DNS. In these embodiments, the various pieces of hardware, software, and functional units of the internet appliance can reside on the ISP DNS server(s), on separate hardware from the ISP DNS server(s), or partially on the ISP DNS server(s) and partially on separate hardware. In certain embodiments, the internet appliance is provided entirely on separate hardware from the ISP DNS server(s). The internet appliance of the invention and the ISP DNS server(s) can be physically connected via cables, wires, or the like. The connection can be direct (i.e., from one to the other without any intervening hardware, except via the connector) or indirect (i.e., through one or more other hardware devices, such as circuit boards, filters, etc.). In other embodiments, the connection is not a physical connection (e.g., it is a connection via electromagnetic energy, such as infrared signals, radio signals, microwave signals, optical signals, and the like). In certain embodiments, the internet appliance is implemented directly within the ISP DNS server or the registry DNS server (e.g., by insertion of a circuit board into the server). In other embodiments, certain functionalities are implemented directly within the ISP or registry servers, while other functionalities are implemented one or more other physical components, which are connected, either physically or non-physically.

In embodiments where the systems and methods are integrated into the registry or ISP servers, such integration can be through physical insertion of one or more circuit boards into the server. In addition, packet filtering and graceful rejection of non-HTTP services can be implemented in one or more firewalls present in the registry or ISP system. Similarly, two or more load balancers can provide landing page redundancy and reliability. Furthermore, hotword, keyword, and locality based services can be implemented by using server side programs or scripts.

Moreover, as disclosed herein, in embodiments the present invention provides features that can reduce computer usage at the user level by using the system in conjunction with the internet infrastructure in such a way that when a query occurs, there is minimal impact upon the user and greatly minimized computer usage required by the user, thus improving the efficient use of the internet infrastructure. There is an added benefit in certain embodiments in that when the query is initiated there is a seamless integration with the entire network.

The present systems and methods are suitable for use in a variety of communication direction applications. For example, in an exemplary embodiment of the present invention as applied to the field of telephony, unused traffic might be a mis-dialed phone number that may then be redirected to a telemarketer or other location or for other services, such as a directory function. In the area of Instant Messaging (IM), unused traffic may be generated, for example, by someone who typed in an incorrect screen name. That mistyped screen name may then be redirected to an advertiser who might flash up a message and/or link or to another location or for other services, such as a directory function. Thus, according to the invention, a landing page can be any location, including, but not limited to a web page, telephone number, and IM screen name, that can provide information in response to a query. Preferably the information is relevant to the query, requestor, or system that is being used by the requestor, but it can be information that directs the requestor to relevant information, simply a message that an error has occurred, or any other information that the operator of the internet appliance wishes.

If processed correctly, unwanted, unused, and/or unresolved traffic would be a very valuable business resource to those seeking such traffic. Indeed, many internet service providers are unaware that they possess this valuable business asset. Today, they view this traffic as the internet equivalent of trash. But, as with many industries, trash can often be recycled and turned into new products. One way to do that is through the present invention, which provides means of directing such unwanted, unused, and/or unresolved traffic to content-relevant web pages, and in doing so, reaping a monetary gain from the owner of that web page. In addition, the ability to direct general queries (e.g., keyword or hotword lookups) to content-relevant sites that can, but are not necessarily, geographically proximate to the requesting computer can create business opportunities and revenues for DNS operators, such as ISPs and/or corporations maintaining servers dedicated to their businesses.

The systems and methods by which traffic can be identified as “unwanted”, “unused”, or “unresolved” within the internet may be accomplished by several means, exemplary embodiments of which will be described herein.

A typical query routing scenario results in a lookup of an IP Address by a DNS server, typically an ISP DNS, that is contacted by a user's internet browser. If, after consultation with the appropriate DNS at the registry level, a requested IP Address is not found on the internet, the request is classified as “unresolved”, and an error message to this effect is returned to the internet browser initiating the request. The present invention provides systems and methods to intercept such error messages and provide content-relevant web page results rather than a simple error message or a redirection by the internet browser to a content-irrelevant web page. In essence, the systems and methods of the invention redirect such error messages away from the user's internet browser to content-relevant web pages. In doing so, the invention eliminates unproductive error messages and unproductive redirection by the internet browser to a content-irrelevant web page that might contain content-irrelevant URLs or advertising.

When the original unresolvable query is sent to the ISP DNS, it is passed up and down the internet infrastructure in an attempt to resolve the requested IP Address, and it is only after all appropriate DNS servers have been contacted that an error message is returned to the requestor. In contrast, the present systems and methods provide for caching of erroneous queries, and thus permit not only content-relevant redirection, but a substantial decrease in the amount of time required for redirection of the unresolvable query if the erroneous query resides in the system's cache.

Furthermore, because the present systems permit caching of information, they can provide the correct IP Address of web sites or web pages that have moved. More specifically, to enhance the speed at which IP Addresses are returned to users, DNS servers typically cache IP Addresses that they know to be valid. The IP Addresses are maintained in the cache for a pre-determined amount of time (called the “time to live” or TTL) before being purged. Once purged, the DNS server must request the IP Address from the root level server the next time that particular IP Address is requested (following the procedure outlined above). However, when a web site or web page is moved from one IP Address to another, the DNS servers within the internet infrastructure are not informed directly of the move, and thus maintain the IP Address in their caches until the TTL expires. After the move, but before expiration of the TTL, requests for the web page or web site are erroneously directed to an expired IP Address. In embodiments, the present systems and methods overcome this drawback by periodically (half-daily, daily, weekly, etc.) caching new IP Addresses for web sites and web pages that have moved, marking the old IP Addresses as unused IP Addresses, and redirecting the traffic to the new IP Address, another relevant IP Address, or a landing page providing the new IP Address, relevant web pages, and/or advertising information.

The present internet appliance, when sitting between a user and the ISP DNS or when integrated, partially or wholly, into the ISP DNS, can identify the IP Address, and thus the location, of the user. This information can be useful in deciding whether certain traffic is “unwanted”, in providing geographically relevant redirection of query results or unresolved queries, and connecting the user to the closest server, defined geographically or by connection pathway length (i.e., number of hops), containing the information requested. This function cannot currently be provided by any known and used system that is implemented at the registry level.

The present internet appliance can be implemented at the level of lookup of a query or at the level of resolution of a query. Examples of implementation at the level of lookup are provided throughout this disclosure. In an exemplary scenario where the present internet appliance is implemented at the level of resolution at corporate web sites, the corporate web sites can identify traffic as unwanted through a number of means. A corporate web site, for instance, may define traffic from overseas as “unwanted” if it were not profitable to ship products overseas. Thus, one could identify if the traffic came from overseas by analyzing the IP Address. Alternatively, a web site owner might only want traffic at certain times, and not at other times and/or geographic locations. By implementing the present systems and methods, such traffic could be sorted by time and/or geographic location wherein such specified portions could be identified and made available as redirected traffic. More specifically, by analyzing the requests for access to its web site, a company may permit some traffic to enter yet filter other traffic out. The denied (filtered) traffic could then be used by the present systems and methods for redirection, or the traffic could be offered for sale to bidders who would be interested in the traffic (based on subject matter, geographic location, time, or any of the other numerous pieces of data that can be collected from the query).

In the area of telephony, unwanted telephone traffic might take the form of a mis-dialed phone number or a misdirected internet call. Or, perhaps, the person typed in the right telephone number, but there is no person associated with that number or the person might no longer work there, or might have a different phone number. In any case, that piece of telephone traffic could be redirected, perhaps to another person within the company that the person is trying to contact, a phone company operator, an outside company to where the person may have transferred, or even a telemarketer. Other options are also possible and immediately apparent to those of skill in the art.

In the instant messaging (IM) world, an “unresolved” piece of traffic could be, for example, a piece of traffic for which there is no screen name associated, such as when a customer types in a screen name that doesn't exist. If it cannot be resolved in the IM database, then the traffic is identified as unresolved and thus may be redirected, and a marketing message and/or website link can be delivered to the consumer.

As shown and described herein, many possible examples exist for the directing or redirecting of electronic communication signals that are not able to find their intended targets. Although many such forms exist, with non-limiting examples being described herein in terms of internet traffic, telephone calls, and the like, the examples described herein are provided with respect to lost internet traffic for sake of simplicity. However, the concepts and architecture is the same with other forms of electronic communication and thus the present invention has a scope that encompasses all electronic communication, beyond that for unresolved internet traffic and keyword and hotword lookups as described in the following series of Figures.

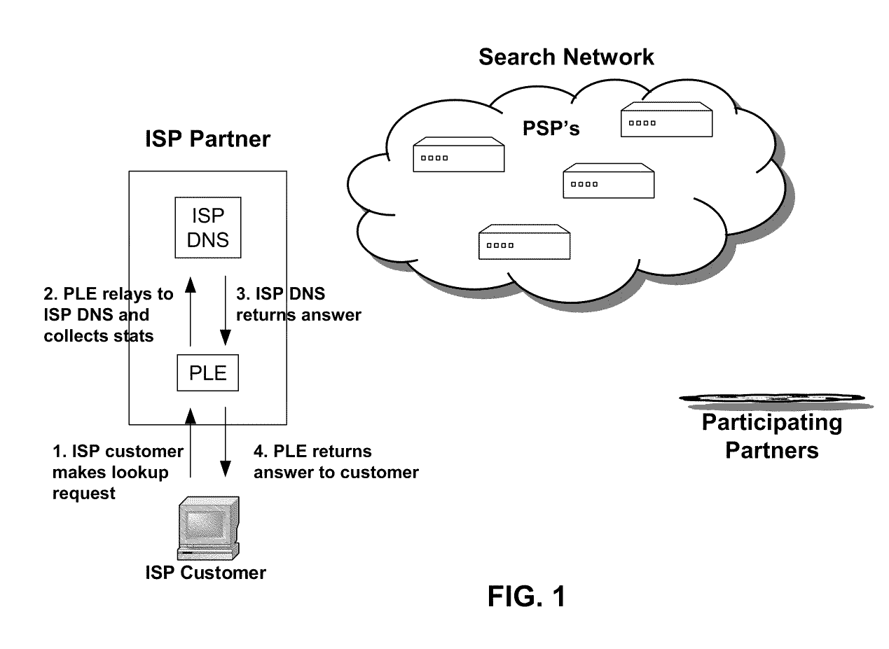

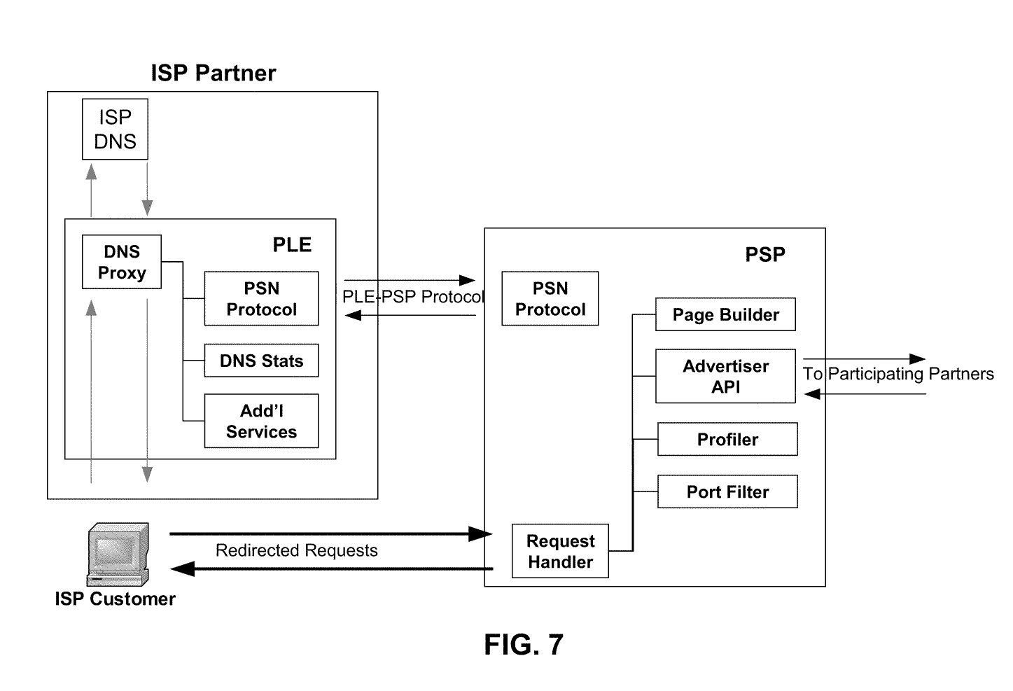

Turning now to the Figures, an exemplary embodiment of the present invention is shown in FIG. 1, wherein a system or method of the DNS Proxy functionality of the PLE is shown. In this embodiment of the invention, an IP Address is properly typed in and located. As is illustrated, an ISP customer (e.g., an individual user) sends a request 1 for an IP Address lookup to the PLE, which then relays a message 2 to the ISP DNS. The DNS collects the necessary statistics relating to the specific IP Address requested by the user and returns 3 the IP Address requested with a domain name that is resolved to the PLE. The PLE returns 4 the requested IP Address to the ISP customer. In such a system or method, the DNS proxy (i.e., the PLE) may collect information and statistics about all DNS requests made to the ISP DNS. This may be accomplished using other functionalities (such as those depicted in FIG. 7), thus building a database for the system and method.

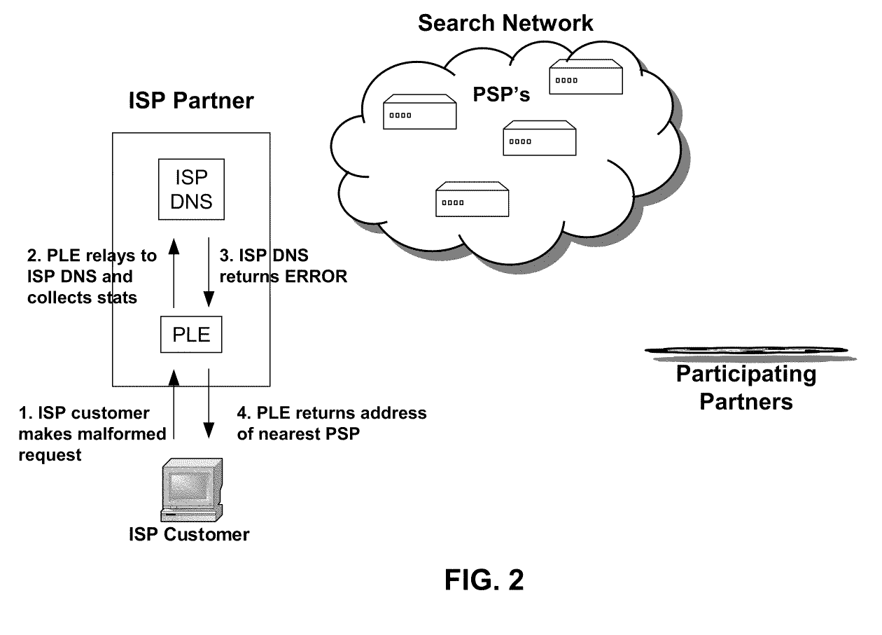

However, as is often the case, an internet user does not properly type in a desired internet address. FIG. 2. shows an example of a malformed DNS request in which a redirect IP Address is returned from a PSP node, for example the nearest (geographically or in terms of number of hops) PSP node. The ISP customer makes a malformed request for an address lookup 1. The PLE relays 2 the malformed request to the ISP DNS and collects statistical data in a data base, then the ISP DNS returns 3 an error such as “no such address” or the like. Then the PLE returns 4 an IP Address of the nearest PSP such that the ISP customer receives a redirect IP Address to this request instead of a DNS error message.

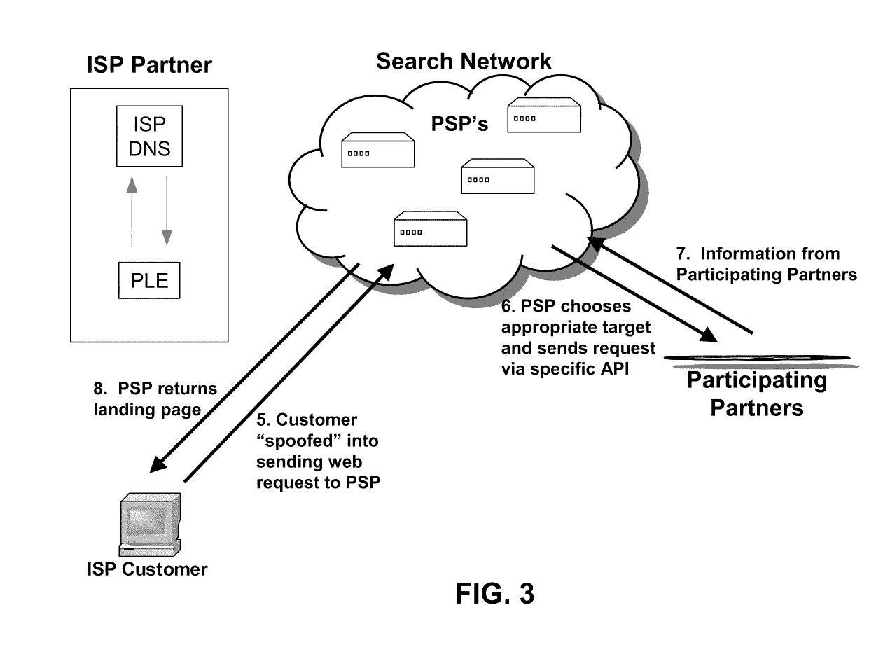

FIG. 2 and FIG. 3 show sequentially the events that take place when the systems and methods of certain embodiments of the present invention are implemented within the internet infrastructure. In FIG. 2, a malformed request 1 for an IP Address is submitted by a user. The request is routed 2 through the PLE to the ISP DNS, which is unable to find the requested IP Address after consultation with its own cache, the root DNS, and other DNS in the internet infrastructure. The ISP DNS returns 3 an error message, which is read by the PLE prior to passing to the requestor. Instead of returning an error message to the requestor, the PLE returns 4 the address of the nearest PSP. As shown in FIG. 3, the requestor's internet browser, thinking it has been supplied the requested information, connects 5 to the PSP. The PSP to which the user is connected dynamically analyzes the request, contacts 6 one or more participating partners, receives 7 information or content from one or more Participating Partners, and creates and returns 8 to the customer a web landing page with a search bar included in the landing page. Not depicted in the figure is the scenario where the PLE recognizes, through consultation with its own cache, that the requested web page or web site is unresolvable (e.g., erroneously typed, expired). In such a scenario, the PLE can redirect the request to the PSP without first consulting the ISP DNS.

The PSP is a functional platform that makes up part of the systems and methods of the invention. The PSP can comprise a single unit of hardware (e.g., a server) or multiple units. The PSP hardware units are referred to herein at times as nodes. Each node of the PSP contains multiple IP Addresses to which the PLE may redirect unresolved queries, along with other relevant information. The PSP can analyze the information provided by the PLE and build a content-specific landing page for display to the requestor. An advantage of these embodiments of the invention is the dynamic nature of the landing page building process. Unlike other redirect systems, the present system dynamically builds a landing page for each unresolved query supplied by the PLE, based on information maintained by the system and provided by participating partners (e.g., advertisers). In this way, a content-specific redirect landing page can be built for each unresolved query, and this content-specific landing page can contain geographically relevant content and time-relevant content as well. This is in contrast to other redirect systems currently used, which build a single redirect landing page in response to certain hotwords or unresolved queries, and provide that redirect landing page regardless of the particular subject matter of the query, location of the requestor, or time of request.

In embodiments, the web page that is returned in response to the user's request contains a search bar (also referred to in the art as a browser bar or URL bar). The search bar is supplied by the PSP within the context of the redirect landing web page, and functions as any typical search bar does. That is, it provides the users internet searching capabilities as would any other search bar, such as performing URL, hotword, and keyword searching. It also provides the user the opportunity to refine his search, particularly when the redirect landing page supplied by the PSP contains relevant information, but not the precise information that the user wished to obtain. Thus, the search bar supplied by the redirect landing page provides convenience for the user in performing further searches, and minimizes confusion that often ensues when a user has multiple search bars resident on his browser page. That is, because the search bar is provided within the redirect landing page, the user will easily remember that he used that search bar rather than one of the many that might be present at the top of his browser display page. Indeed, it is envisioned that users will be able to eliminate all browser bars from their browser display page, thus freeing up desktop space without losing functionality. With respect to this concept, because a user will be able to use any of the common search engines using the browser bar supplied by the redirect landing page from the PSP, there will be no need for the user to maintain multiple browser bars on his browser display page. In addition, the browser bar provided by the PSP as part of the landing page also enhances the business opportunities for participating partners because further searches performed by the user can result in landing pages that contain content-relevant advertising, as, for example, along the right side or top of the screen.

At this point, it is noted that many of the figures depict “Participating Partners”. By Participating Partners, it is meant entities (individuals, companies, organizations, etc.) that supply content, such as advertisements, services, or other information (e.g., information on government programs, university offerings, etc.) to the PSP. This content is made available to the PSP for display in response to an unresolved query relating to a particular subject, geographical area, time, etc. that is relevant to the Partner. The PSP uses this content to dynamically build a redirect landing page for each unresolved query sent by the PLE. The PSP operator, the DNS owner, or some other entity implementing the systems and methods of the present invention typically charges the Participating Partners to display the Partner's content. Under this scenario, both the PSP operator, DNS owner, etc. and the Partner reap monetary gains from providing the relevant content—the PSP operator, etc. receives payment for displaying the content and the Partner gets targeted advertising, which is known to result in a high rate of return. That is, ad targeting is known to be a highly effective and efficient means of advertising, and the Partner will reap the benefits of this type of advertising by supplying information to be displayed when a query that is relevant to its business is received by the PSP.

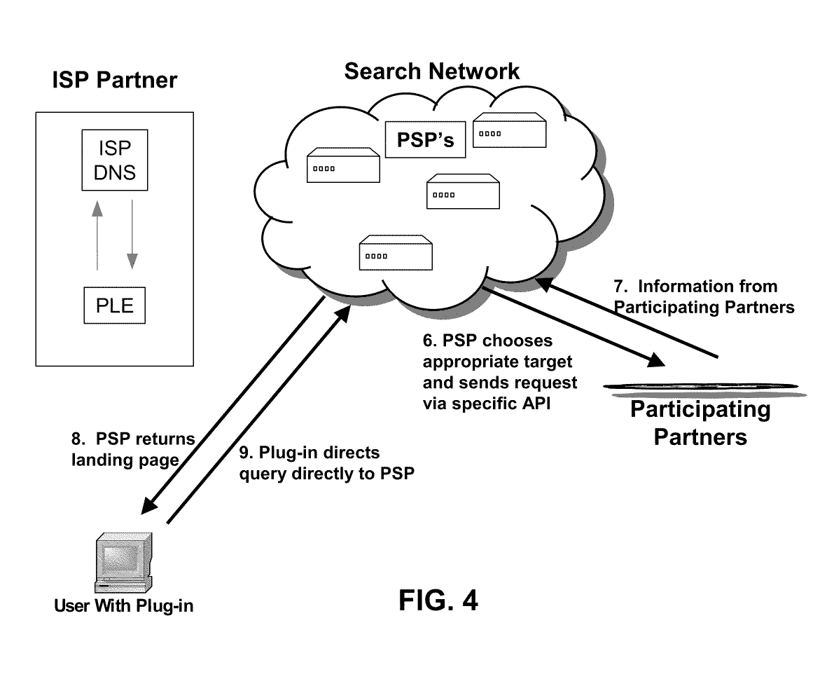

In some cases, a user might want a plug-in to drive the system. In these cases, the present invention provides a plug-in (referred to herein as PSM), which can be specific for any type of request (e.g., web page, e-mail, internet telephone, IM, etc.). For example, when the user wishes to use a plug-in to route all web page requests to the PSP, the PSM can be installed on his personal computer, and the user will be assured of sending web requests only to the PSP. However, if the PSM is not also configured to route e-mail address requests, IM requests, or other internet traffic requests to an appropriate PSP, the PSP may filter out the non-web page traffic and return an error response appropriate for the request. Implementation of a plug-in within the present internet appliance according to certain embodiments is depicted in FIG. 4. In FIG. 4, it is shown that a request, such as an HTTP request, from a user is directed 9 from the plug-in directly to the PSP of the internet appliance, without a first consultation with the PLE, PSP DNS, or internet infrastructure. The PSP dynamically builds and returns 8 a landing page for the user based on the various information provided to the PSP from the query 9 and any other information stored at the PSP that is relevant to the query or the user, which is sent 6 to one or more Participating Partners, and blended with information 7 from one or more Participating Partner.

Throughout this disclosure, the concept of filtering is discussed. The present systems and methods permit filtering of information that passes through them. That is, information that is received by the systems and methods of the invention can be analyzed for content, origin (geographic, IP Address, MAC address), time, and other relevant parameters. This information can be used to determine whether the query is passed through because it contains information that has been defined as not relevant (or forbidden) for processing. It can also be used to determine whether the query is to be processed (e.g., redirected to a redirect landing page). Likewise, it can be used to determine if the query should be returned to the sender as an erroneous query. One can immediately envision numerous other reasons why a query would be filtered and either passed through, processed, or returned, and all such reasons are contemplated by the present invention. For example, queries may be filtered for objectionable words, phrases, or graphics, and either redirected to a web page informing the sender of the inappropriateness of the objectionable subject matter. It can also be filtered based on the requested IP Address (e.g., it is possible to use the present internet appliance to block access to certain internet sites, such as those providing pornography or other content that is defined by the user or operator of the appliance as objectionable). In addition, as discussed throughout this disclosure, unresolvable queries may be filtered to a redirect landing page. Furthermore, in embodiments where the PSP is configured to accept only web page requests, e-mail requests can be filtered, either passing through the system, after analysis or untouched, or returned to the sender with an error message.

As with other functionalities of the present systems and methods, filtering is a function, and thus can be provided on one or more physical components of the system. In certain embodiments, it is integrated into one or more firewalls used by a DNS operator. In other embodiments, it is resident within a unit of hardware comprising the PLE and/or PSP. The filtering functionality has been found to be useful, but not highly necessary at the PLE platform. In exemplary embodiments, filtering at the PLE platform (e.g., at the DNS Proxy) is used to identify words, phrases, or bit strings that are defined by the operator as impermissible. For example, certain operators of the present internet appliance might wish to block all traffic that contains certain words that are defined by the operator as offensive. The filtering functionality of the PLE may be used to intercept all traffic containing such words, and redirect the user to a landing page that explains that the message has been intercepted, and that traffic containing the offending bit string, etc. is not permitted.

In contrast, although not required, for best performance of the system, it has been found that the filtering functionality should be provided at the PSP platform. For example, in the scenario where the PSP has been implemented to dynamically create redirect landing pages for erroneous web page queries only, if it does not filter out non-web page queries, it will use resources, perhaps a high percentage of resources, attempting to create landing pages for these non-web page queries. Such fruitless attempts would tie up system resources and potentially limit the robustness of the systems and methods. Thus, in preferred embodiments, filtering is provided at the PSP.

As depicted in FIGS. 3 and 4, the PSP may return customer-specific, geographically-relevant, and/or time-relevant content based upon the request or a profile stored for that particular requesting computer or ISP. The participating partner, which could be an advertising partner, a search engine partner, an ad network, a distributor of an ad network, and the like returns 7 content for the specific customer, for the location of the requesting computer or ISP, and/or based on the subject matter of the query. This can be done through a common Application Program Interface (API) to the Participating Partners or defined by the Participating Partners. The PSP builds and sends 8 a launch page with content from the Participating Partner(s). This launch page is built dynamically in real time based upon profile information stored for the ISP or based upon the IP Address of the requestor, which includes information about the geo-location of the requesting computer. The IP Address may be used to localize the requestor all the way down to a known individual user.

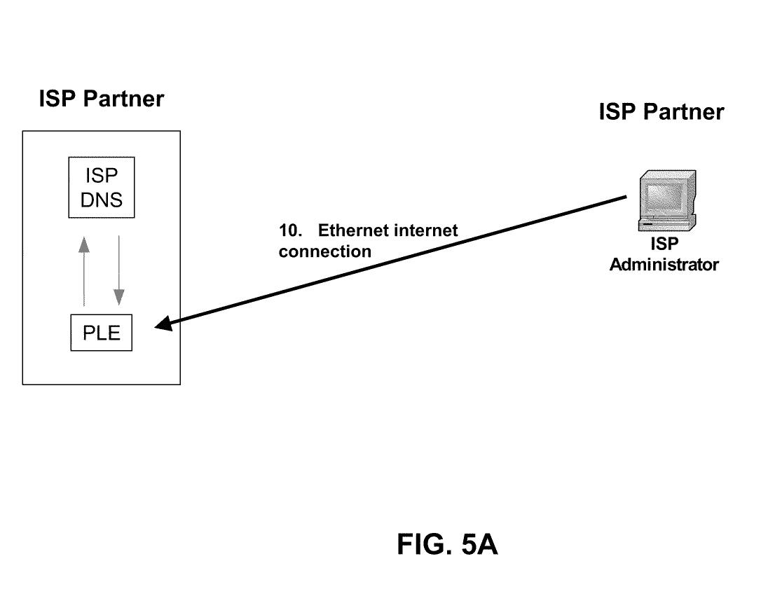

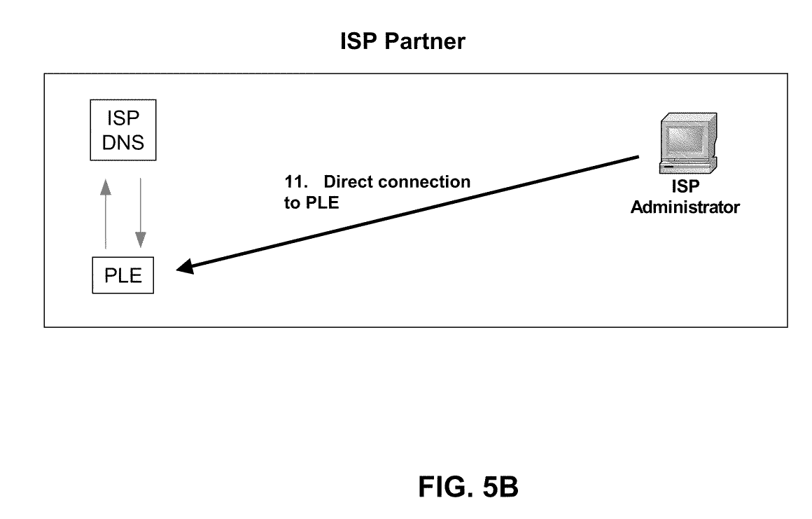

FIGS. 5A and 5B show two examples of the internet appliance of the invention in which an ISP, as controller of the systems and methods of the invention, may use a web-based interface or a direct link, such as a hardwire connection, to communicate with and control the PLE. FIG. 5A depicts a scenario where the ISP, through its administrator, contacts the PLE (which, in this embodiment, is assigned an IP Address known only to the ISP) via the internet to update, configure, etc. the PLE. An advantage of this embodiment is that an ISP may make changes to multiple PLE platforms from a single location, and, potentially at the same time. FIG. 5B depicts a scenario where the ISP Administrator contacts the PLE (which in this embodiment has no IP Address, and thus is not accessible via the internet) via a direct connection, such as through a wire connection, optical connection, infrared connection, etc. to update, configure, etc. the PLE. An advantage of this embodiment is that the PLE does not have an IP Address, and is thus secure from internet-based attacks. Typically, the ISP would want to access the PLE to configure and manage the DNS proxy functionality within the PLE, and to check or update the status of the PLE DNS proxy and the redirect landing pages that are returned to a user in response to an unresolved query. However, under certain circumstances, the ISP might wish to use the web-based interface or direct link to configure its ISP profile on the PSP or to perform any number of other tasks.

One feature that is optionally available in the internet appliance of the present invention is an option to use the redirect capabilities of the internet appliance or to not use the redirect capabilities. This is referred to herein as an opt-in/out capability, and is implemented in preferred embodiments to provide users relying on one or more DNS implementing the internet appliance of the invention the option of using other redirect methods. In essence, the PLE of the invention can be thought of as a “smart wire” that can analyze information coming from a user or from the internet infrastructure, and either use that information to execute one or more functions (thus functioning in an intelligent way), or ignore the information (thus acting as a wire). The ability to make this distinction resides within the internet appliance, and does not require any other hardware or software. However, in embodiments, to implement the opt-in/out feature, the PLE redirects the user to the PSP, which creates a landing page containing a message informing the user that he has been redirected, and that he may opt out of the service if he wishes. In embodiments where a plug-in is used, the plug-in directs the user to the PSP, which creates the landing page.

Once a user has opted in or out of the service, the PLE, PSP, or both can retain the election state and apply that state to all further queries originating from the IP Address or MAC Address associated with the computer being used. Of course, the internet appliance is capable of applying the opt-in/out election to numerous computers within a given network, or to an entire network, if given the command from a computer with proper authority. Likewise, the redirect service of the internet appliance of the invention may be disabled (i.e., converted to an opt-out status) for certain types of queries, but not others. For example, a particular user may opt-out of e-mail redirection and URL redirection, but opt-in for hotword and keyword searches. In addition, the user, network administrator, etc. may change the opt-in/out status of the service at any time, and for any length of time (e.g., one session, one day, one week, permanently, etc.) by accessing the PLE operator (e.g., the ISP or other relevant DNS operator) through its web site, telephone number, or other contact information, or by accessing a web page operated by another provider of internet services. For example, one may opt-in or opt-out through an ISP administrator who can manually configure the PLE such that the PLE is statically configured for a particular IP Address to the desired status. In addition, an ISP administrator could create blocks of IP Addresses, or DHCP zones, into which IP Addresses are assigned, one zone for those users who choose to opt-in, and one zone for those users who choose to opt-out.

The opt-in/out status can be depicted for a user at various times or under various circumstances, as can the choice to opt-in or opt-out. For example, on the landing page generated by the PSP in response to a request to opt-out, the user might see a link saying something to the effect of “Would you like to opt-out from this service?” By selecting this link, the user's IP Address will automatically be sent to the PLE so that the next time the user sends a DNS packet, it will be forwarded to the DNS server without any PLE processing. As such, the user will have opted-out of the internet appliance's redirect service. In contrast, a user may go to an appropriate web page and select an opt-in link, at which point the IP Address of that computer will be forwarded to the PLE with instructions to set the status as opt-in. In other embodiments, to opt-out, the user may uninstall the browser plug-in that was previously downloaded or may use the plug-in to access a web page that permits opt-in/out status to be registered. Other suitable specific ways of opting in and out can be envisioned by those of skill in the art, and any such way can be implemented in accordance with the present invention.

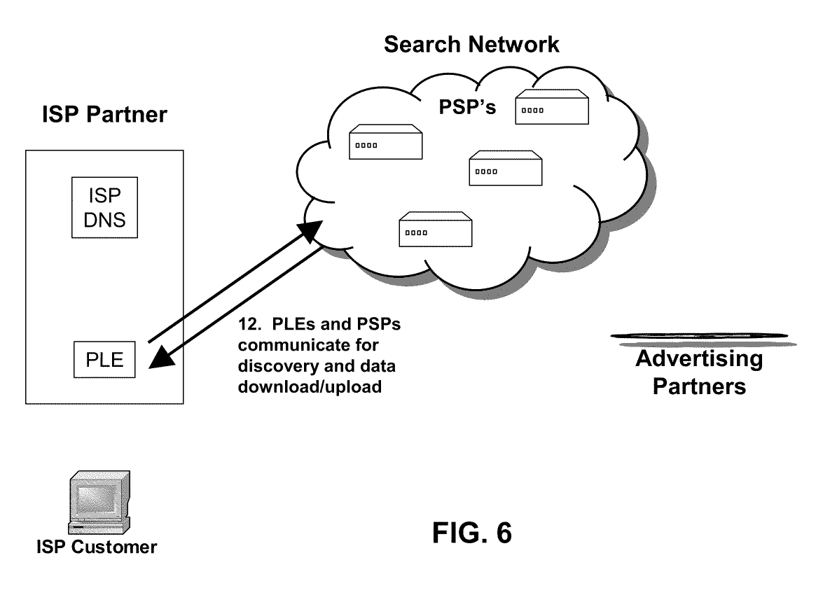

FIG. 6 shows that the PSP and PLE platforms communicate with each other continuously or periodically. Communication may relate to any number of things, including, but not limited to the functional status of each PLE and each PSP within the system, the availability and current processing load of each PLE and PSP within the system, the content of records maintained on each PLE and PSP within the system, and for various other functions. For example, this communication may be used for updates and self-coordination between the PLE and PSP, or can be used to pass opt-in and opt-out status for particular IP Addresses. Such updates may be initiated by the PSP or PLE automatically, or initiated by the PSP or PLE manually by a human operator. The updates further may be module, software, or data updates. They may also be used to deploy new PLE service modules. The data that the PSP provides to the PLE includes the IP address which is to be returned when an unresolved domain name request is made.

As shown in the exemplary sequences of FIGS. 1-6, certain ISP information directing methods and systems according to the present invention can involve a number of components. FIG. 7 is a description of certain components of an individual PLE platform and an individual PSP platform according to embodiments of the internet appliance of the invention. One advantageous aspect of certain architectural configurations of the present internet appliance derives from the fact that the PLE is a general purpose software engine. As such, it can run software modules other than those of the present invention to deliver other services at this infrastructure layer. In addition, it is to be noted that the internet appliance is not limited in the number of pieces or location of hardware that are depicted and discussed in exemplary embodiments, and that other hardware and software may be included in different embodiments, such hardware and software being implemented for various functions typically performed by computers and internet trafficking servers.

As an overall summary, FIG. 7 shows that the internet appliance of the invention can be generally broken into two aspects, the PLE platform and the PSP platform, each of which provides various functionalities. According to the embodiment depicted in FIG. 7, the PLE comprises four functionalities, the DNS Proxy, the PSN Protocol, the DNS Stats, and the Additional Services. Other embodiments may provide fewer or more functionalities. In addition, the PSP platform provides six functionalities, the PSN Protocol, the Request Handler the Page Builder, the Advertiser API, the Profiler, and the Port Filter. Other embodiments may provide fewer or more functionalities. Each platform provides multiple functionalities for stability, load bearing, and availability of functions. In embodiments, the internet appliance comprises more than one of each of the PLE and PSP to further improve functioning of the appliance through improved stability, load bearing, and availability.

In a typical scenario for handling an unresolved query that is not detected at the PLE cache, a DNS request is made by an ISP customer, the DNS Proxy of the PLE intercepts the DNS request (i.e., IP Address request) at a port, such as port 53, and passes on the request to the ISP DNS. If an error message is returned by the ISP DNS, the DNS Proxy will return an IP Address of a PSP node. At that time, the PSN Protocol of the PLE informs the PSN Protocol of the PSP that a redirect page relating to certain content is being sent to the user's browser. The PSP, through the Page Builder and Advertiser API, dynamically builds a redirect landing page at the IP Address supplied to the user by the PLE. When the user's web browser contacts the IP Address supplied by the DNS Proxy of the PLE, a content-relevant redirect web page is displayed on the user's computer screen.

The PSN protocol module is what communicates between the PLE and PSP. This allows real-time data updates between the PLE and PSP. The PLE can send information, such as, for example, DNS stats, status, information about the owner of IP Addresses, and information from additional service modules. The PSN can add new server modules to the PLE, can update the PLE software, can return response to queries, and can return the IP Addresses to be returned in place of error messages from the DNS.

The DNS Stats module collects statistics about DNS requests and the status of the requests. It can collect those stats or send that information to the PSP via the PSN protocol module. For example, it can collect statistics about how many erroneous requests are submitted by a certain IP Address in a certain amount of time. This information could be useful in identifying sources of spam or hacking activities. Other examples of useful information that could be collected and processed will be immediately apparent to those of skill in the art, and all such examples are encompassed by this invention.

In FIG. 7, the functionality of Additional Services is depicted. Such services can be any services contemplated as useful to the system operator or Participating Partner, and can include back-up services, which can be implemented on-line or off-line for added security. Indeed, in preferred embodiment, the DNS Stats module can be backed up periodically through the Additional Services functionality, providing a storage place for statistics, as well as a convenient place to store restore functions in the event of a PLE platform failure. The additional services can be provided as a web addressable feature, for convenient transmission of statistics to another computer over the internet, or it can be an “off-line” function that can only be accessed by a controller having physical access to the Additional Services hardware. The latter embodiment provides added security against information on particular IP Addresses or MAC Addresses becoming available to the public.

The PSP Request Handler handles the request from ISP customers when they are directed to an error landing page. In essence, the Request Handler is the functional unit of the PSP that communicates with the requestor. It sends information from the requestor to other functional units within the PSP platform, and returns a built redirect landing page to the requestor.

The Request Handler employs the Port Filter to filter out any non-relevant queries that are received by the Request Handler. For example, if the PSP is implemented to provide redirect landing pages for web page queries only, all non-HTTP protocol or other port requests other than HTTP will be filtered by the Port Filter. Filtering at this point or before reduces system inefficiencies and permits a faster redirect web page display. As discussed above, preferred embodiments include a filter, such as the Port Filter, within the PSP platform. In embodiments, the Port Filter function is provided as part of a general firewall for the operator of the systems and methods of the invention.

The Profiler is used to define the look and feel and layout of a landing page. It can contain profile information about the ISP, the customer, or any other information that is available to it. For example, many users are accustomed to a certain layout for a web page, whether it be a search page or a landing page displaying results of a search. The Profiler can maintain information on the ISP serving each user, and provide a redirect landing page that emulates the ISP search page. Alternatively, the Profiler can determine whether the user has used a particular search engine to submit the query, and provide a redirect landing page that emulates that search engine's page. Then again, if the Profiler has collected information from the user from previous visits, it can build a landing page that contains elements that were indicated by the user as desirable, or that were used preferentially by the user (thus implying that such features were preferred). Numerous other parameters can be used to define the look and feel and layout of a landing page, and all such parameters are envisioned and encompassed by this invention.

The Page Builder module builds the PSP landing page in real-time in response to the profile of either the user, the ISP, or both that are stored in the Profiler. Of course, part of this profile is the content of the malformed request that brought the user to the PSP in the first place. As noted above, the Page Builder functionality dynamically synthesizes each redirect landing page based on the information provided by the Profiler. Thus, each landing page provided by the PSP is potentially different from every other landing page provided in the past or future. This is in sharp contrast to other redirect systems, which provide a static landing page that is revised only periodically, and not based on the particular combinations of subject matter, geographical location, time, and/or other information, such as personal information, that is available from information retained on the ISP side of the internet.

It is important to note that the PLE and PSP, while being implemented through hardware and software, are functional platforms made up of functional elements. Thus, each platform may exist on a single or multiple different pieces of hardware. Furthermore, each functional unit may be resident on a single or multiple different pieces of hardware, located in the same geographical area or in widely dispersed geographical areas. It is well within the skill of those of skill in the art to implement different functions on different pieces of hardware, which are either directly connected or connected through one or more intervening pieces of hardware. Likewise, although software to control different functionalities that are located on different pieces of hardware, or that exist as multiple copies within the system is part of the present invention, other software that can be implemented to further control certain aspects of the methods and systems, which can be implemented by the operator of the invention based on various desires, can be integrated into the present invention without undue or excessive experimentation by one of skill in the art.

To this point, the internet appliance of the present invention has been described in terms of its functions when implemented to analyze and redirect queries as they arrive from a user or as information regarding the query is returned from the internet infrastructure, or alternatively as it is implemented by way of a browser plug-in. It is to be understood, however, that the internet appliance, while providing these and other functions, need not provide all of the functions discussed herein in each embodiment. For example, the internet appliance of the invention may provide redirection of known unresolvable queries (e.g., queries for a particular web page that no longer exists, or a web page that has been defined as a page that is an unwanted landing page) only, without forwarding the query to the internet infrastructure to obtain further information regarding the query. In addition, it may forward all queries to the internet infrastructure without initial analysis at the PLE to determine if the query contains an unresolvable bit packet (based on consultation with the PLE cache). As a particular example, it is possible for the internet appliance of the present invention to redirect keyword searches only, hotword searches only, or keyword and hotword searches, but not mis-typed queries. In doing so, the internet appliance may recognize the keyword and/or hotword search as an improper IP Address query, and redirect the query to a PSP generated landing page without consulting the internet infrastructure. Alternatively, for example, when the internet appliance encounters a mis-typed query, it need not first analyze the query to determine if it is unresolvable (by consultation with known unresolvable queries maintained in its cache), but simply pass the query on to the internet infrastructure for resolution. On the other hand, it may direct all queries, whether resolvable or not, to a redirect landing page without analyzing the query or receiving any information from the internet infrastructure. Furthermore, the internet appliance may be configured to permit improper IP Address requests (e.g., keywords or hotword) to be sent to the internet infrastructure for resolution, then use the information received from the internet infrastructure along with other information known to the appliance to generate a relevant redirect landing page. As is evident from the present disclosure, when a plug-in is implemented, one or more of the functions of the PLE may be obviated or incorporated into the plug-in function. Accordingly, the internet appliance of the present invention is not limited to an appliance that provides all of the functions described herein, but rather it is one that provides one or more functions, which can be selected and combined based on the preferences and needs of the DNS operator implementing the internet appliance.

Thus, in embodiments, the internet appliance of the invention comprises at least one processor that receives a query from a user, analyzes the query, redirects the user to a redirect landing page if pre-defined conditions are met, and passes the query on to the internet infrastructure if pre-defined conditions are not met. Analyzing can be any manipulation of data that requires recognition of one or more bit sequences. Thus, analyzing can include converting a human language request into an IP Address request and determining whether the IP Address is resolvable, determining the IP Address of the user, determining the MAC Address of the user, identifying a bit string, and the like. As discussed above, pre-defined conditions can be any number of things, including IP Address of the request, IP Address or MAC Address of the user, bit strings that have been defined as impermissible, the format of the query (e.g., hotword, keyword, HTTP, SMTP, etc.), or the like. In embodiments, the redirect landing page is generated by a PSP.

In embodiments, the internet appliance comprises at least one processor that receives a query from a user; passes the query on to the internet infrastructure, receives information from the internet infrastructure; analyzes the information received from the internet infrastructure; and directs the query to a first landing page if certain pre-defined conditions are met, or passes on the information from the internet to the user or directs the query to a second landing page is those conditions are not met. Analyzing can include any or all of the functions discussed herein. In certain embodiments, the processor(s) of the appliance analyze information received from the query and/or synthesizes information received from the query and the internet. Thus, in embodiments, one or more processor collects and retains information upon receipt of query, collects and retains information upon receipt from internet infrastructure, or both. The pre-defined conditions can be any of those discussed herein, including but not limited to unresolved unresolvable queries, or the opt-in or opt-out status of the user.

In yet other embodiments, the internet appliance comprises at least one processor that receives a query from the user and redirects it to a landing page. For example, the internet appliance may be a plug-in that automatically directs all queries to a PSP-generated landing page. In embodiments, the processor(s) may analyze the query (i.e., information residing in the query or the information associated with the query) before redirecting. In embodiments, the processor(s) may analyze the information in or associated with the query and pass the query to the internet infrastructure if one or more pre-defined conditions are or are not met.

In preferred embodiments, the internet appliance comprises one or more processors that can build a landing page based on information associated with the query, the information returned from the internet infrastructure, or both. In embodiments, this landing page is generated by the PSP functions of the internet appliance. Functions of the PSP include, but are not limited to, receiving information from the PLE, dynamically building a landing page for queries, and synthesizing information provided by the query, cached information from the PLE or PLP based on the user's IP Address, MAC Address, or other relevant information.

As mentioned above, the functions discussed above can be provided on a single processor or two or more processors, the functions being distributed among the processors in accordance with the designs of the operator of the appliance. As used herein, a processor is any hardware, software, or combination of two or more of either or both that can process information within the framework of a computer system. Examples of processors include, but are not necessarily limited to, central processing units (CPU), circuit boards, chips, software, and the like. Where multiple processors are used, they can be connected in serial or parallel. That is, the multiple processors can perform their assigned functions, whether it be a function provided solely by the processor or a function that is redundant to or shared by other processors, at the same time other processors are performing their assigned functions, or one or more processor can act only after one or more other processor has completed its function. In embodiments, the internet appliance is used to direct keyword, hotword, or mis-typed internet queries. In embodiments, the internet appliance is implemented as a plug-in. The internet appliance may be implemented at any layer of the internet architecture, including Layer 2, Layer 3, or Layer 4.

In view of the disclosure above, in a particular embodiment, the internet appliance comprises: a processor that receives a query generated at a point of origin; a processor that analyzes the query to determine if it is resolvable or unresolvable or contains one or more pre-defined bit strings; a processor that submits the query to the internet infrastructure to resolve the query if it is resolvable; a processor that directs the query to a landing page if it is unresolvable or contains one or more pre-defined bit strings; a processor that receives information about a resolvable query from the internet infrastructure; a processor that analyzes the information about a resolvable query received from the internet infrastructure; a processor that forwards to the point of origin of the query information regarding a resolvable query that is resolved and that is received from the internet infrastructure; a processor that directs the query to a landing page if the information from the internet infrastructure indicates that the query was unresolved; and a processor that builds a landing page for each unresolvable or unresolved query or each query containing one or more pre-defined bit strings.

In some situations, all of the processors except the processor that builds a landing page are physically linked and located within a single computer chassis, and/or the processor that builds a landing page is located at a separate physical location from the other processors. Likewise, in some situations, all of the processors except the processor that builds a landing page are physically linked and located within a single computer referred to as a lookup proxy or lookup engine, and/or the lookup proxy/engine is located between the point of origin of the query and the first DNS to which the query is submitted.

As is evident from the above disclosure, multiple pieces of hardware and combinations of hardware and software can be used to implement the internet appliance of the present invention. Thus, in embodiments, the internet appliance can comprise means for receiving a query generated at a point of origin; means for analyzing the query to determine if it is resolvable or unresolvable or contains one or more pre-defined bit strings; means for submitting the query to the internet infrastructure to resolve the query if it is resolvable; means for directing the query to a landing page if it is unresolvable or contains one or more pre-defined bit strings; means for receiving information about a resolvable query from the internet infrastructure; means for analyzing the information about a resolvable query received from the internet infrastructure; means for forwarding to the point of origin of the query information regarding a resolvable query that is resolved and that is received from the internet infrastructure; means for directing the query to a landing page if the information from the internet infrastructure indicates that the query was unresolved; and means for building a landing page for each unresolvable or unresolved query or each query containing one or more pre-defined bit strings; or any sub-combination of these.

In view of the above disclosure, in embodiments, the invention provides methods of directing internet traffic. The methods can comprise receiving a query from a user, analyzing the query, redirecting the user to a redirect landing page if pre-defined conditions are met, and passing the query on to the internet infrastructure if pre-defined conditions are not met. Analyzing can be any manipulation of data that requires recognition of one or more bit sequences. Thus, analyzing can include converting a human language request into an IP Address request and determining whether the IP Address is resolvable, determining the IP Address of the user, determining the MAC Address of the user, identifying a bit string, and the like. As discussed above, pre-defined conditions can be any number of things, including IP Address of the request, IP Address or MAC Address of the user, bit strings that have been defined as impermissible, the format of the query (e.g., hotword, keyword, HTTP, SMTP, etc.), or the like. In embodiments, the redirect landing page is generated by a PSP.

In embodiments, the method of directing internet traffic can further comprise analyzing information received from the query and/or synthesizing information received from the query and the internet. Thus, in embodiments, the method comprises collecting and retaining information upon receipt of query, collecting and retaining information upon receipt from internet infrastructure, or both. The pre-defined conditions can be any of those discussed herein, including but not limited to unresolved unresolvable queries, or the opt-in or opt-out status of the user.

In yet other embodiments, the method of directing internet traffic comprises receiving a query from the user and redirecting it to a landing page. For example, the method may be implemented by an internet appliance that is a plug-in that automatically directs all queries to a PSP-generated landing page. In embodiments, the methods may analyze the query (i.e., information residing in the query or the information associated with the query) before redirecting. In embodiments, the methods may analyze the information in or associated with the query and pass the query to the internet infrastructure if one or more pre-defined conditions are or are not met.

In preferred embodiments, the method of redirecting internet traffic comprises building a landing page based on information associated with the query, the information returned from the internet infrastructure, or both. In embodiments, this landing page is generated by the PSP functions of the internet appliance. Functions of the PSP include, but are not limited to, receiving information from the PLE, dynamically building a landing page for queries, and synthesizing information provided by the query, cached information from the PLE or PLP based on the user's IP Address, MAC Address, or other relevant information.

In particular embodiments, the method of directing internet traffic comprises: receiving a query generated at a point of origin; analyzing the query to determine if it is resolvable or unresolvable or contains one or more pre-defined bit strings; submitting the query to the internet infrastructure to resolve the query if it is resolvable; directing the query to a landing page if it is unresolvable or contains one or more pre-defined bit strings; receiving information about a resolvable query from the internet infrastructure; analyzing the information about a resolvable query received from the internet infrastructure; forwarding to the point of origin of the query information regarding a resolvable query that is resolved and that is received from the internet infrastructure; directing the query to a landing page if the information from the internet infrastructure indicates that the query was unresolved; and building a landing page for each unresolvable or unresolved query or each query containing one or more pre-defined bit strings. In certain embodiments, building a landing page comprises receiving information regarding the query; analyzing the information for content of the query, content of the information from the internet infrastructure, point of origin of the query, geographic location of the point of origin of the query, time of submission of the query, or any combination of two or more of these; synthesizing the information with one or more piece of information already known about the content of the query, content of the information from the internet infrastructure, point of origin of the query, geographic location of the point of origin of the query, time of submission of the query, or any combination of two or more of these; submitting information about the query to one or more participating partners, to the internet infrastructure, or both; receiving information regarding the query from one or more participating partners, the internet infrastructure, or both; synthesizing the information received from the participating partners, internet infrastructure, or both; and building a landing page based on the information received from the participating partners, internet infrastructure, or both.

In certain embodiments, the method further comprises filtering out unwanted queries. In embodiments, building a landing page is a dynamic process that is performed for every query based on information that is relevant to that query. It is envisioned that the information analyzed is in the form of bits or strings of bits.

The above disclosure clearly indicates that the present invention encompasses a method of doing business using a computer, for example, over the internet. The method comprises: directing an unresolvable or unresolved query to a dynamically created landing page that contains information that is relevant to the subject matter of the query, point of origin of the query, geographic location of the point of origin of the query, time of submission of the query, information provided by the internet infrastructure, or any combination of two or more of these; and charging a provider of the relevant information a fee for inclusion of the information in the landing page. In embodiments, the method is a method of ad targeting using the internet. In preferred embodiments, the method is implemented before or at the ISP level of the internet architecture. The method of doing business using a computer includes methods in which the query comprises one or more hotwords, one or more keywords, or a mis-typed query (or mis-dialed number, mis-typed IM screen name, etc.; all of which are encompassed herein by the terms unresolved or unresolvable).

In one exemplary implementation of the invention, a component, which can run as a module in the general purpose software engine (i.e., the PLE) is the collection and/or analysis of DNS and other traffic. Including this component opens opportunities to partner with researchers, ISPs, and marketing firms to study internet performance. In addition, when the present invention is implemented on ISP DNSs and other DNSs, the PLE will make it possible to deliver additional services such as “DNS forwarding” for known changes to DNS names, “URL filtering” to control access to undesirable web sites, detection and diagnosis of DDOS attacks, and detection and diagnosis of Spam sources.

A failed-lookup service, as provided by the present invention, is useful to ISP customers. Such customers will be given appropriate controls (e.g., opt-out feature, as discussed above). The technical model shown and described assures other applications work as expected. The model creates opportunities for other useful services for customers. This model creates a network uniquely positioned to instrument and study internet performance dynamics. It is not a rigidly enforced mechanism and offers complete choice to the user. ISPs can participate without redirection (e.g., for other services) or ISP customers have the choice to opt-in or opt-out. The options are in place for both the customer and the ISP. In addition, the invention provides for opt-in and opt-out of the services provided on a time-limited or content-limited basis, if desired by the user or ISP. Thus, use of the system by an ISP or a user can be controlled based on any number of considerations, and can be changed at the discretion of the ISP or individual user at each logon, or even each search.

In a preferred embodiment, for simple traffic redirection, the system can identify a piece of unwanted, unused, or unresolved traffic and point it to a particular location (i.e., any IP Address), such as a search engine, any IP Address of a web server, and/or any IP Address of any server for any port or protocol. Other options are also possible and are left to the controller of the system and method as described herein.

In a preferred embodiment for use with traffic direction and processing, the traffic is processed before it is redirected. Such processing may, for example, include identifying or approximating the location and/or demographics of the entity that initiated the traffic. This may be accomplished, for example, using geo-location and/or demographic analysis. The IP Address of the requestor may be discovered ahead of time by any ISP that delegates either a static IP Address or uses a dynamic means such as DHCP to delegate an IP Address to a particular user. When the secondary request is made, for example another web landing page, the identity of the user can then be determined by the IP Address of the requestor to bind a particular DNS request with a particular requestor. When the systems and methods of the invention sit at or before the ISP DNS layer, and particularly when they utilize Layer 2 processing, the IP Address of the requestor can be mapped and bound to a Media Access Control (MAC) address, thus providing more information and certainty to the relevance of the redirection. The ability to bind a particular IP Address to a particular MAC Address also enables an efficient opt-in/out functionality to be provided by the present internet appliance.

In embodiments, the location of the requestor can be used to provide geographically relevant information in response to a keyword or hotword search. More specifically, because a keyword or hotword is not a valid URL or e-mail address, the present systems and methods can treat it as an unresolved query. As such, the systems and methods can intercept the request before it reaches the ISP DNS (or whatever DNS is implementing the invention) and redirect it to the PSP, which will generate a redirect landing page that contains relevant information. In the case of a keyword, it can be a web page sponsored by a Participating Member. In the case of a hotword, it can be a search page containing results of a web search, content-relevant advertisements, or both. In either case, when the present invention is implemented at the ISP or on the user side of the ISP, the IP Address and even MAC Address of the requestor will be available to the system, and can be taken into account when dynamically building the landing page. For example, advertisements from companies only in the general or specific area of the computer making the request might be displayed on the landing page. As such, the requestor will see ads from companies in his geographical area, and the Participating Partner (advertiser) will get highly effective ad targeting to his audience. Likewise, in response to a keyword search, a web page from a local company in a business related to the search term will be provided, rather than a web page from a company somewhere else in the country or world. While the geo-location of the requestor is of great interest to the Participating Partners in providing ad targeting, it can also benefit the user by providing web search results that are ranked based on location, which could be important when searching for products, services, or points of interest in the user's locale.

As discussed above, in embodiments, the methods and systems of the invention redirect traffic to web pages that are hosted by entities that pay for such redirection, or display links to such entities. Thus, in these embodiments, the invention provides methods of doing business using a computer, such as over the internet. One example of such methods and systems involves allowing potential buyers of redirection services to bid on various traffic before it is redirected. This embodiment can involve simple traffic redirection, in which case the traffic can be sold on an individual basis or in bulk, for example. Alternatively, this embodiment can involve a processing step allowing the traffic to be classified by one or more criteria, such as geographic location and/or demographics, for the purpose of selling the traffic to parties interested in receiving such traffic from a particular location and/or demographic. In yet another embodiment, traffic can be classified based on time, and time-relevant advertising can be displayed. For example, many eating establishments provide discounts on days of sporting events. The present invention would allow those establishments to target their ads to internet users who are searching at or near the time of the sporting event, searching for information relevant to the type of food they serve, searching for the sporting event, or searching for information relevant to the time around which the sporting event will take place. Such ad targeting is highly cost effective, and provides a benefit to the entity implementing the present invention (by obtaining revenue from the Participating Partner), the Participating Partner (by receiving a high rate of return on the advertising investment), and the user (by finding discounted prices on food).

A variety of different systems and methods may be employed within the scope of the present invention both to identify unwanted, unused, or unresolved traffic and to redirect such traffic, once identified as such. In addition, a variety of systems and methods may be employed within the scope of the present invention to direct keyword and hotword queries to content-relevant web pages.

Exemplary systems and methods according to the present invention have a variety of industrial and corporate uses. For example, in the corporate arena, internet merchants receive a significant amount of traffic that they do not want or need. For instance, any traffic a merchant receives from a foreign country is worthless to him if it is unprofitable or illegal for that merchant to ship his product or provide his services in that foreign country. The present systems and methods can be implemented at the merchant's DNS server to filter out unwanted traffic. This traffic can be discarded or can be sold to one or more internet traffic merchants as re-direct traffic.

Another exemplary use area is at internet registries, which help direct traffic from user to his final destination on the internet. The registry DNSs frequently cannot figure out where to send a unit of traffic. According to the present invention, this traffic is classified as unresolved traffic. This happens billions of times a day on the internet, and thus provides a great source for revenue generation.

In one non-limiting every day example of implementing the present invention, the systems and methods of the invention are implemented by an ISP. An average internet user who is seeking out a dentist in his geographic area may accidentally type in the wrong address (URL) for the dentist. Systems and methods of the present invention can determine that the user is seeking out a dentist and can determine the general location of the computer of the user, for example through zip code. Armed with the various pieces of information available to the system, including for example the spelling of the malformed query and the location of the requesting computer, the system can search all dentists in its Participating Partner (e.g., advertisers) database to determine which are available in the area of the zip code of the particular user. The system then presents the user with a web page of information that relates to dentists in the same zip code, or the zip code and surrounding zip codes. In this case, although the user typed in the wrong URL for a particular dentist, the ISP provider was able to provide the user with a list of dentists in the user's area. The user might find the particular dentist who was the subject of the search, or another dentist (or a number of dentists) in the area. This service is beneficial for the user who is seeking a dentist (and may have been seeking one who is closer or more economical), the ISP provider (who gains from the advertising revenues), and the dentist (who has paid for advertising to the ISP and is now having customers directed to him). The ability to provide geographically relevant results in response to unresolved queries is not possible from redirect systems that are resident in web browsers on a particular user's computer or from redirect systems that could be deployed at the registry level of the internet infrastructure unless the user provides the information explicitly.

Other examples are limitless and within the scope of the present invention. For example, misdialed telephone calls may operate under the same structure, providing the caller with additional options other than the party that the caller had intended to call (but whose number the caller mis-dialed).

Yet another example involves broken links. There are literally billions of links on the web that are “broken”, meaning that when a consumer clicks on the link, he doesn t end up where he intended, but, rather, on an “error” page. These broken links can be collected and the traffic they generate can be redirected to another place, such as a related page.

Yet another example includes parked domains. “Parked” domains are domains that have been registered by a consumer or business, but for which there is no actual web site attached by the registered owner of that domain. These parked domains are typically maintained by the registrars that sold the domain. Even though there is no website attached to these domains, they still generate traffic. This traffic, which otherwise would never be processed and thus would be lost, can be redirected to another place.

Many other uses are possible. These include:

(1) the instant after a query is made. Redirecting traffic from one supplier of traffic to one buyer of traffic. This may be called “one-to-one” business system;

(2) redirecting traffic from one supplier to many buyers. This may be called “one to many” business system;

(3) redirecting traffic from many suppliers to many buyers of traffic. This may be called “many to many” business system; and

(4) any combination of the above embodiments may be used in addition to that of systems currently being used, thus aiding the usefulness of current system as well as reducing the associated maintenance cost by reducing the rate of requests that are directed to content-irrelevant web pages.

Further advantages of the invention can include, in embodiments, reduction of overhead usage of the components involved in the end user's computer system, addition of stability to the internet infrastructure, and increased reliability. One or more of these advantages can be achieved while simultaneously reducing the maintenance associated with current internet redirect systems. One advantage of the exemplary embodiments of the present invention is to provide means for recovering unresolved traffic and converting such traffic into money for the ISPs, other operators of DNS servers, and/or participating business partners. Another beneficial result of implementing exemplary embodiments of the invention is to provide a system and/or method for internet traffic redirection, which permits a myriad of services to be provided to the customer directly through an ISP and/or participating partner.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the principles of the invention in their broader aspects may be applied to other network systems such as for telephony. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. An internet appliance comprising hardware implementing:
a processor that receives a query from a point of origin;
a processor that analyzes the query;
a processor that directs the sender of the query to a landing page without passing the query to the internet infrastructure if one or more pre-defined conditions are met, but passes the query to the internet infrastructure if the pre-defined conditions are not met,
wherein at least one of the pre-defined conditions is the condition that the query is not associated with a protocol other than the hypertext transfer protocol (HTTP).

2. The internet appliance of claim 1, comprising one processor.

3. The internet appliance of claim 1, wherein the query contains a keyword, a hotword, or a mis-typed IP Address.

4. The internet appliance of claim 1, further comprising a processor that synthesizes information received from the query and the internet.

5. The internet appliance of claim 1, further comprising a processor that builds the landing page.

6. The internet appliance of claim 1, wherein a pre-defined condition is an internet protocol (IP) address providing objectionable content.

7. The internet appliance of claim 1, comprising
a processor that receives a query generated at a point of origin,
a processor that analyzes the query to determine if it is resolvable or unresolvable or contains one or more pre-defined bit strings,
a processor that submits the query to the internet infrastructure to resolve the query if it is resolvable,
a processor that directs the sender of the query to a landing page if it is unresolvable or contains one or more pre-defined bit strings and if it is not associated with a protocol other than HTTP,
a processor that receives information about a resolvable query from the internet infrastructure,
a processor that analyzes the information about a resolvable query received from the internet infrastructure,
a processor that forwards to the point of origin of the query information regarding a resolvable query that is resolved and that is received from the internet infrastructure,
a processor that directs the sender of the query to a landing page if the information from the internet infrastructure indicates that the query was unresolved or if the original query contained one or more pre-defined bit strings, and
a processor that builds a landing page for each unresolvable or unresolved query or each query containing one or more pre-defined bit strings.

8. The internet appliance of claim 7, comprising a single processor.

9. The internet appliance of claim 7, wherein the processor that directs the sender of the query to a landing page if it is unresolvable or contains one or more pre-defined bit strings is a processor that directs the sender of the query to a landing page without passing the query to the internet infrastructure if it is unresolvable or contains one or more pre-defined bit strings when the query is not associated with a protocol other than HTTP.

10. An internet appliance comprising hardware implementing:
a processor that receives a query from a point of origin;
a processor that passes the query on to the internet infrastructure;
a processor that receives information from the internet infrastructure;
a processor that analyzes the information received from the internet infrastructure; and
a processor that directs the sender of the query to a first landing page if one or more pre-defined conditions are met, or passes on the information from the internet to the point of origin or directs the sender of the query to a second landing page if one or more of the pre-defined conditions are not met,
wherein at least one predefined condition is the condition that the query is not associated with a protocol other than HTTP.

11. The internet appliance of claim 10, comprising one processor.

12. The internet appliance of claim 10, wherein the query contains a keyword, a hotword, or a mis-typed IP Address.

13. The internet appliance of claim 10, further comprising a processor that synthesizes information received from the query and the internet.

14. The internet appliance of claim 10, further comprising a processor that builds the first and/or second landing pages.

15. The internet appliance of claim 10, wherein a pre-defined condition is an internet protocol (IP) address providing objectionable content.
